(19) United States
(12) Patent Application Publication
(10) Pub. No.: US 2007/0100893 A1
(43) Pub. Date: May 3, 2007

(54) System and method for accessing data from a memory device

(75) Inventor: Richard Sanders, Hutto, TX (US)

Correspondence Address: TOLER SCHAFFER, LLP, 8500 BLUFFSTONE COVE, SUITE A201, AUSTIN, TX, 78759, US

(73) Assignee: SigmaTel, Inc., Austin, TX (US)

(21) Appl. No.: 11/262,903

(22) Filed: Oct. 31, 2005

(51) Int. Cl. G06F 17/30

(52) U.S. Cl. 707/200

(57) ABSTRACT

The disclosure is directed to a portable device including a solid-state memory device and a processor. The solid-state memory device includes a data object including stored data and associated object-based organization data. The solid-state memory device is responsive to the processor. The processor is configured to access the solid-state memory device to retrieve the stored data from the data object and configured to communicate the stored data using a mass storage class (MSC) communication protocol.

### FIELD OF THE DISCLOSURE

This disclosure, in general, relates to systems and methods for accessing data from and storing data on a memory device.

### BACKGROUND

Increasingly, consumers are demanding portable electronic devices, such as personal digital assistants (PDA), MP3 players, portable storage systems, advanced wireless telephones, cameras, and other handheld devices. Traditional non-volatile storage mediums, such as hard drives, floppy drives, and other storage devices are generally unsuitable for portable devices. These typical devices generally have moving parts and, as such, are subject to mechanical failure. In addition, such devices are bulky and consume a large amount of energy. As a result, developers are turning to solid-state non-volatile memory devices, such as electrically erasable programmable read-only memory (EEPROM) and flash memory, for use in portable products.

In typical portable systems, data stored on a non-volatile solid-state memory device is organized into a file allocation table (FAT) file system originally designed for traditional magnetic media. Typically, the file system includes, for example, a boot sector, which includes basic file system information and, in some examples, includes pointers to logical locations of other sectors and an operating systems boot loader code. The filing system may also include a FAT region, which includes a file allocation table (FAT). In addition, the filing system may include a root directory region that stores a directory table including information about files and directories in the root directory. In addition, the filing system references a data region where the actual file and directory data is stored. In general, FAT file systems are organized into clusters and sectors. Data stored in the data region is stored in clusters. A file may include data stored on more than one cluster, and a cluster typically includes data from a single file.

Generally, a file is accessed by determining a location of the file from the file allocation table and requesting data from that location. For example, the file allocation table may include a linked list of clusters associated with a file. The file may be assembled by accessing the clusters in the order of the linked list. To facilitate an organized presentation of the data to a user, a directory table includes information which organizes the files into a set of directories, commonly referred to as folders.

For solid-state memory devices, the logical organization of the file system may not much the physical organization of the solid-state memory device. Solid-state memory devices, such as flash memory devices, reorganize data to balance usage of physical blocks of memory to prevent wear on the device. As such, accessing systems typically perform a translation from the logical address of the file system to the physical address in use by the solid-state memory device, slowing file and data access.

As such, improved systems and methods for accessing data from solid-state memory devices would be desirable.

### BRIEF DESCRIPTION OF THE DRAWINGS

FIGS. 1 and 2 include illustrations of exemplary embodiments of a data storage system.

FIG. 3 includes an illustration of an exemplary data object for storage by a data storage system, such as the exemplary data storage systems illustrated in FIGS. 1 and 2.

FIGS. 4, 5 and 6 include illustrations of exemplary methods for use by data storage systems, such as the exemplary data storage systems illustrated in FIGS. 1 and 2.

### DESCRIPTION OF THE DRAWINGS

In a particular embodiment, the disclosure is directed to a portable device including a solid-state memory device and a processor. The processor may be, for example, a controller and the solid-state memory device may be responsive to the controller. In an exemplary embodiment, the solid-state memory device includes data organized using an object-based organization system. The processor is configured to access the solid-state memory device to retrieve the data and is configured to provide the data using a file allocation table (FAT) compatible format, such as via a mass storage class (MSC) communication protocol. In an exemplary embodiment, the object-based organization is compatible with media transfer protocol (MTP). Particular embodiments of the portable media device may be useful as a thumb-drive storage device or a portable digital audio player.

In a particular embodiment, the disclosure is directed to a portable device including a solid-state memory device and a processor. The solid-state memory device includes a data object including stored data and associated object-based organization data. The solid-state memory device is responsive to the processor. The processor is configured to access the solid-state memory device to retrieve the stored data from the data object and configured to communicate the stored data using a mass storage class (MSC) communication protocol.

In another exemplary embodiment, the disclosure is directed to a method of accessing data stored in a solid-state memory device. The method includes receiving a mass storage class (MSC) request for a data file, determining a data object associated with the data file, and accessing data associated with the stored data object. The data is stored in the solid-state memory device.

In a further exemplary embodiment, the disclosure is directed to a method of accessing data in a solid-state memory device. The method includes storing a data object in the solid-state memory device. The data object includes metadata and data. The metadata includes a virtual file allocation table data. The method further includes reading the virtual file allocation table data from the data object and generating a virtual file allocation table based at least in part on the virtual file allocation table data.

The disclosure is also directed to, for example, a method of storing data in a solid-state memory device. The method includes receiving a mass storage class (MSC) communication including data for storage and generating a data object. The data object includes metadata and the data for storage. The metadata includes a virtual file allocation table data. The method also includes storing the data object in the solid-state memory device.

In addition, the disclosure is directed to a solid-state memory device configured to store a data object. The data object includes metadata and data. The metadata includes virtual file allocation data.

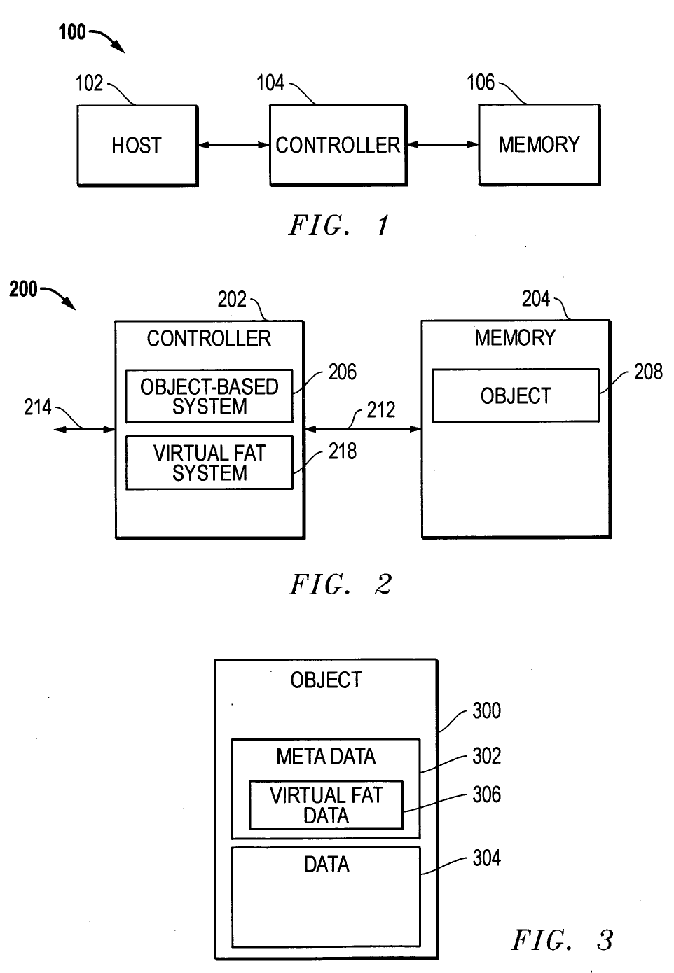

FIG. 1 includes an illustration of an exemplary system 100 that includes a controller 104 and a memory device 106. The memory device 106 is responsive to the controller 104. In addition, the system 100 may include a host device 102 in communication with the controller 104. In an exemplary embodiment, the host device 102 is a remote device that communicates with the controller 104 via a serial interface, such as a universal serial bus (USB) interface. In another exemplary embodiment, the host 102 and the controller 104 may form a portion of a system-on-a-chip that may be implemented in a combination of software and hardware. In a further example, the controller 104 may be a processor. The host device 102, the controller 104, and the memory device 106 may be housed together or separately, or may be remotely housed.

In an exemplary embodiment, the system 100 is a portable device including the controller 104 and the memory device 106. The portable device may be, for example, a portable memory device, such as a thumb drive including flash memory, or a portable hard drive accessible via a USB interface. In another example, the portable device may be a portable media player, such as an MP3 player or portable video player. Such portable devices may be configured to store data, and, in particular, may be configured to store media data, such as audio or video data.

In an embodiment, the memory device 106 is a solid-state memory device, and, in particular, is a non-volatile solid-state memory device. For example, the memory device 106 may be a flash memory device, such as a NAND flash memory device.

The controller 104 may be configured to organize data for storage on the memory device 106 in an object-based organizational system. For example, the controller 104 may be configured to organize data into objects based on organizational systems, such as Reiser FS or Reiser 4 systems. In an exemplary embodiment, the controller 104 is configured to organize data into objects that are compatible with object-based communications protocols, such as media transfer protocol (MTP). Media transfer protocol (MTP) is a protocol for communication and control of devices, such a portable media devices, which permits object exchange. As such, the memory device 106 may include data organized as a set of objects. In a particular embodiment, organizational objects may include container objects that reference data objects of various types. A data object type may include, for example, an audio object type, a video object type or a file object type.

When the host 102 accesses the controller 104 using an object-based communication request, such as an MTP communication, the controller can readily determine the object requested and access that object from the memory device 106. For example, the host may send data for storage using an MTP communication and the controller 104 may generate an object to which the data is stored on the memory device 106. In another example, the controller 104 may receive an MTP request for an object and the controller 104 may access the object from the memory device 106.

In an exemplary embodiment, the controller 104 includes a virtual FAT filing system. The virtual FAT filing system may be generated based on the object-based organization and a directory table may be generated based on container objects and data objects associated with the container objects. When a host device 102 accesses the controller 104 using a file-based communication, such as a mass storage class (MSC) communication, the controller 104 may determine an object associated with the requested data and access the object from the memory device 106. The controller 104 may translate the object into an MSC compatible response and provide the data in a file-based format. Further, the controller 104 may provide the host device 102 with the virtual file allocation table and a virtual directory table in response to a request by the host device 102.

In a particular embodiment, the controller 104 and the memory 106 are included in a portable memory device, such as a thumb drive. The portable memory device may include a universal serial bus (USB) port. As such, the portable memory device may be coupled with a host device 102 having a compatible USB interface. Depending on the communication protocol used by the host device 102, the host device 102 may access the controller 104 using a file-based request or an object-based request. For example, the host device 102 may use a file-based request, such as a USB MSC communication. In another example, the host device 102 may communicate with the controller 104 using an object-based communication, such as a USB MTP communication. Based on the communication format used by the host 102, the controller 104 may respond using an object-based communication protocol or a file-based communication protocol. When the request format is an object-based format, the controller 104 may determine the object associated with the communication and access the object from the memory device 106. When the communication uses a file-based format, the controller 104 may intercept the communication, determine an object associated with the communication, access the object, and prepare a file-based communication in response to the communication from the host device 102. In this manner, a communication received by the controller 104 in an object-based format such as MTP, may be handled using the native organization stored on the memory device. In contrast, a communication using a file-based format, such as MSC, may be translated and interpreted to determine an object and the object data translated to a file-based response.

In an exemplary embodiment, FIG. 2 includes an illustration of an exemplary storage system 200, which includes a controller 202 and a memory device 204. The controller 202 includes an interface 214, such as a USB interface. In addition, the controller 202 includes an interface 212 to the memory device 204. The controller 202 includes an object-based system 206, which interacts with the memory device 204 to store objects, such as object 208, on the memory device 204. In a particular embodiment, the object-based system 206 is a system, such as a Reiser FS system or a Reiser 4 system. In addition, the controller 202 may include a virtual FAT filing system 210. In one exemplary embodiment, the virtual FAT filing system 210 includes a virtual file allocation table and a virtual directory table. In addition, the virtual FAT filing system may include a table associating a logical address with an object.

When the controller 202 receives a request via interface 214 in an object compatible format, such as a USB MTP request, the object-based system 206 determines an object associated with the communication and accesses that object from the memory device 204. For example, the communication may include a request for an object. The object-based system 206 accesses the object from the memory device 204 for transferring in response to the request. In another exemplary embodiment, the communication includes an object for storage on the memory device 204. The object-based system 206 directs the memory device 204 to store the object. When storing the object, the controller 202 may also generate virtual file allocation table data for storage with the object. For example, the system 206 may store a virtual file allocation table data in the metadata of the object 208. In a particular embodiment, the object-based system 206 interacts with the virtual FAT system 210 to determine the virtual file allocation table data to be stored in the metadata of the object 208.

When a request is received by the controller 202 via the interface 214 in a file-based format, such as a USB MSC request, the request may be intercepted by the virtual FAT system 210. For example, a file-based communication may request a file allocation table or a directory table. The virtual file allocation table system 210 may provide the virtual file allocation table or the directory table in response to the request. When the file-based communication includes data for storage on the memory device 204, the controller 202 may generate an object for storing the data included in the file-based communication. The object may include virtual file allocation table data in metadata and the virtual file allocation table and directory table may be updated. In a particular embodiment, the virtual file allocation table includes logical locations that are associated with an object. When a request for a file is received, the virtual file allocation table system 210 translates the request for data into an object identity. The object associated with the object identity may be retrieved from the memory device 204 by the object-based system 206.

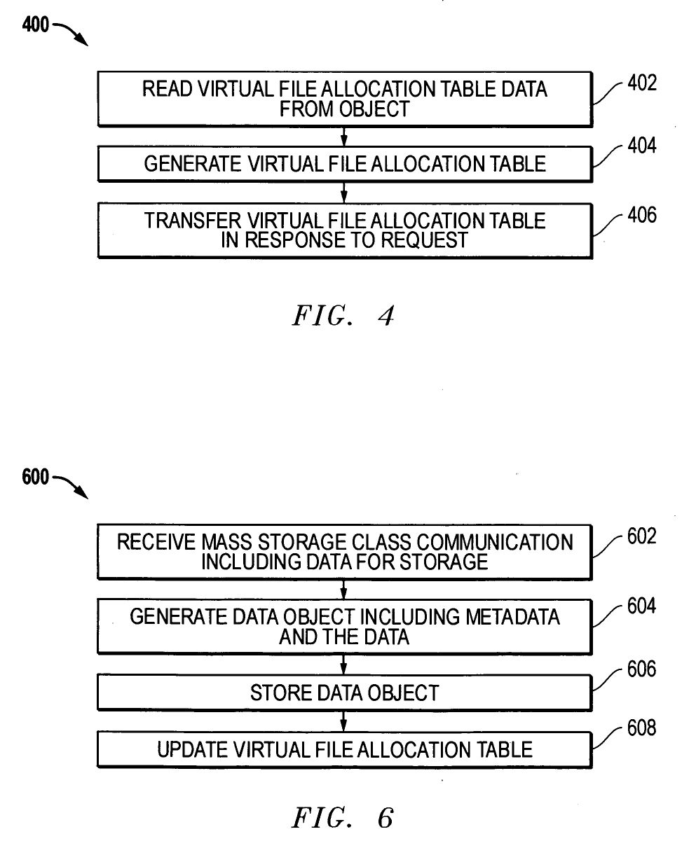

In an exemplary embodiment, data is stored as objects, as illustrated in FIG. 3. For example an object 300 may include metadata 302 and data 304. Typically, the metadata 302 includes information such as object type and information about the data. In a particular embodiment, a media object may include information about an artist, album, and copyright data. In addition, the metadata 302 includes a virtual FAT data 306. In a particular embodiment, the virtual FAT data 306 includes logical address information, such as logical cluster data. The logical address information may be useful in identifying the object 300 when a request associated with the logical address location is received.

Upon initialization of a device or after a writing operation, the system may access the virtual FAT data 306 from the data object 300 to generate a virtual file allocation table and a virtual directory table. When a request is received for a file, the virtual file allocation table system may determine which object is associated with that file and the controller may retrieve the data 304 from the data object 300. For example, a host system may request a file allocation table and determine a logical file location based on the virtual file allocation table provided by the controller. The host system may request data from the logical location. The controller may intercept the request and translate the logical location to an object 300. As such, the data 304 of the object 300 may be incorporated into a file-based communication that is transferred in response to the request.

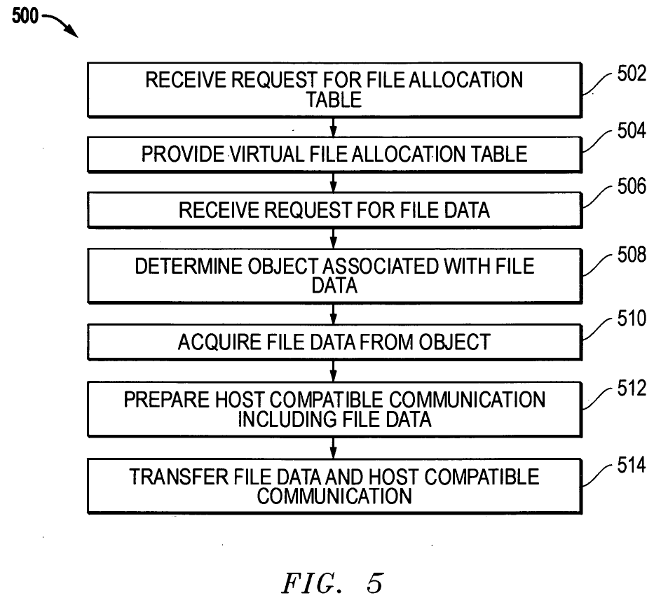

For example, FIG. 4 includes an example of an exemplary method for accessing data stored on a memory device. The method 400 includes reading the virtual file allocation table data from a data object, as illustrated at 402. For example, each data object, including container objects and media objects, may include metadata that includes virtual file allocation table data. In the exemplary embodiment, the virtual file allocation table data includes information to identify the object when a logical address is request by a host system. The virtual file allocation table data may also include information, such as file name, extension, attributes, creation time, and address of the first logical cluster, useful in generating a virtual directory table.

Based at least in part on the virtual file allocation table data, the system may generate a virtual file allocation table and a virtual directory table, as illustrated at 404. The system may generate the directory table based at least in part on virtual file allocation table data gathered from container objects and data objects. For example, the virtual file allocation table may include entries for logical clusters and the root directory table may include information about virtual files associated with objected, including an address for a first logical cluster.

In response to a request, the system may transfer the virtual file allocation table, as illustrated at 406. In addition, the system may transfer a virtual directory table. For example, the system may receive a request in a file-based format for data from a FAT region and directory region of a memory device. In a particular embodiment, the system may receive a request for a first logical cluster of a memory device. The system may intercept this request and provide the virtual file allocation table and virtual directory table in response to the request.

Using the virtual file allocation table and virtual directory table, a host device may request data from a logical location of the memory device. In an exemplary embodiment, FIG. 5 includes an illustration of an exemplary method 500 for accessing data from the memory device. For example, the system may receive a request for a file allocation table and root directory table, as illustrated at 502. In a particular embodiment, the host device may request data from a logical address that is associated with a FAT region and a directory region of a memory device. In response, the system may provide the virtual file allocation table, as illustrated at 504. The system may also provide a virtual directory table.

Using the virtual file allocation table and the virtual directory table, the host device may determine which file data is to be requested and a location of the file data. The host device may request data from the location. As such, the system may receive the request for the file data from the host device, as illustrated at 506. In a particular embodiment, the request is an MSC request including a logical address and may include a sector and offset location associated with a virtual file associated with an object.

Based on the file request, the system may determine an object associated with the file, as illustrated at 508. For example, the file request may include a location of data to be accessed. The system may determine that the location is associated with an object based at least in part on a table associating an object with a logical location. As such, the system may access the object to acquire the requested data, as illustrated at 510.

Once the requested data has been acquired, the system may prepare a file-based communication including the file data for transfer to the host device. For example, the system may prepare a host compatible communication including the file data, as illustrated at 512, and transfer the file data with the host compatible communication to the host, as illustrated at 514.

When a host device provides data for storage, the system may generate an object in which to store the data and store the object on the memory device. For example, FIG. 6 includes an illustration of an exemplary method 600 for storing data received in a file-based communication format. In an exemplary embodiment, the system receives a mass storage class (MSC) communication including data for storage, as illustrated at 602. For example, the mass storage class communication may include the data for storage and a logical location at which the data is to be stored. In response, the system may generate an object including the data and including metadata associated with the object, as illustrated at 604. In an embodiment, the metadata includes virtual FAT data. In a particular embodiment, the virtual FAT data includes information about the logical location.

In an example, the system may store the data object on the memory device, as illustrated at 606. In addition, the system may update the virtual file allocation table, as illustrated at 608, and may update a directory table.

In accordance with various embodiments, the methods described herein may be implemented as one or more software programs running on a computer processor. Dedicated hardware implementations including, but not limited to, application specific integrated circuits, programmable logic arrays and other hardware devices can likewise be constructed to implement the methods described herein. Further, alternative software implementations including, but not limited to, distributed processing or component/object distributed processing, parallel processing, or virtual machine processing can also be constructed to implement methods described herein.

It should also be noted that software that implements the disclosed methods may optionally be stored on a tangible storage medium, such as: a magnetic medium, such as a disk or tape; a magneto-optical or optical medium, such as a disk; or a solid state medium, such as a memory card or other package that houses one or more read-only (non-volatile) memories, random access memories, or other re-writable (volatile) memories. The software may also utilize a signal containing computer instructions. A digital file attachment to e-mail or other self-contained information archive or set of archives is considered a distribution medium equivalent to a tangible storage medium. Accordingly, the disclosure is considered to include a tangible storage medium or distribution medium as listed herein, and other equivalents and successor media, in which the software implementations herein may be stored.

Although the present specification describes components and functions that may be implemented in particular embodiments with reference to particular standards and protocols, the invention is not limited to such standards and protocols. For example, object-based organizing systems, such as ReiserFS and Reiser4, represent examples of the state of the art. Such standards are periodically superseded by faster or more efficient equivalents having essentially the same functions. Accordingly, replacement standards and protocols having the same or similar functions as those disclosed herein are considered equivalents thereof.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A portable device comprising:
a solid-state memory device including a data object including stored data and associated object-based organization data; and
a processor, the solid-state memory device responsive to the processor, the processor configured to access the solid-state memory device to retrieve the stored data from the data object and configured to communicate the stored data using a mass storage class (MSC) communication protocol.

2. The portable device of claim 1, wherein the data object is compatible with media transfer protocol (MTP).

3. The portable device of claim 1, further comprising a universal serial bus (USB) interface responsive to the processor, the processor configured to provide the data using the mass storage class (MSC) communication protocol via the universal serial bus (USB) interface.

4. The portable device of claim 1, wherein the solid-state memory device includes a non-volatile memory device.

5. The portable device of claim 4, wherein the non-volatile memory device is a flash memory device.

6. The portable device of claim 5, wherein the flash memory device is a NAND flash memory device.

7. The portable device of claim 1, wherein the solid state memory device includes a plurality of objects, each object including object-based organization data, the object-based organization data including metadata, the metadata including virtual file allocation table data.

8. The portable device of claim 7, wherein the processor is configured to access the plurality of objects and generate a virtual file allocation table based at least in part on the virtual file allocation table data.

9. The portable device of claim 7, wherein the processor is configured to access the plurality of objects and generate a virtual directory table based at least in part on the virtual file allocation table data.

10. The portable device of claim 7, wherein the virtual file allocation table data includes logical cluster data.

11. The portable device of claim 1, wherein the processor is configured to receive a mass storage class communication requesting a file allocation table and wherein the processor is configured to provide a virtual file allocation table in response to receiving the mass storage class (MSC) communication requesting the file allocation table.

12. The portable device of claim 11, wherein the processor is configured to receive a mass storage class (MSC) request for the data and to determine the data object including the data.

13. A method of accessing data stored in a solid-state memory device, the method comprising:
receiving a mass storage class (MSC) request for a data file;
determining a data object associated with the data file; and
accessing data associated with the stored data object, the data stored in the solid-state memory device.

14. The method of claim 13, wherein the solid-state memory device is a non-volatile memory device.

15. The method of claim 13, wherein the mass storage class (MSC) request includes a sector and offset location of the data file.

16. The method of claim 13, wherein the stored data object includes metadata including virtual file allocation table data.

17. The method of claim 16, further comprising generating a virtual file allocation table based at least in part on virtual file allocation table data.

18. The method of claim 17, further comprising providing the virtual file allocation table in response to a request for a file allocation table.

19. The method of claim 13, further comprising:
receiving a mass storage class (MSC) communication including the data file for storage;
generating the data object including metadata and the data of the data file, the metadata including a virtual file allocation table data; and
storing the data object in the solid-state memory device.

20. A method of accessing data in a solid-state memory device, the method comprising:
storing a data object in the solid-state memory device, the data object including metadata and data, the metadata including a virtual file allocation table data;
reading the virtual file allocation table data from the data object; and
generating a virtual file allocation table based at least in part on the virtual file allocation table data.

21. The method of claim 20, wherein the virtual file allocation table data includes logical cluster data.

22. The method of claim 20, further comprising generating a directory table based at least in part on the virtual file allocation table data.

23. The method of claim 20, further comprising:
receiving a request for a file allocation table from a host device; and
providing the virtual file allocation table to the host device.

24. The method of claim 23, further comprising providing a directory table in response to receiving the request.

25. A method of storing data in a solid-state memory device, the method comprising:
receiving a mass storage class (MSC) communication including data for storage;
generating a data object, the data object including metadata and the data for storage, the metadata including a virtual file allocation table data; and
storing the data object in the solid-state memory device.

26. The method of claim 25, wherein the virtual file allocation table data includes logical cluster data.

27. The method of claim 25, further comprising generating a virtual file allocation table and a directory table based at least in part on the virtual file allocation table data.

28. The method of claim 27, further comprising:
receiving a request for a file allocation table from a host device; and
providing the virtual file allocation table to the host device in response to the request.

29. The method of claim 28, further comprising providing a directory table in response to receiving the request.

30. A solid-state memory device configured to store a data object, the data object including metadata and data, the metadata including virtual file allocation data.

31. The solid-state memory device of claim 30, wherein the data object is compatible with media transfer protocol (MTP).

32. The solid-state memory device of claim 30, wherein the virtual file allocation data includes logical address location information.
